(19) United States
(12) Patent Application Publication
(10) Pub. No.: US 2026/0133851 A1
(43) Pub. Date: May 14, 2026

(54) LOAD BALANCING DISTRIBUTION OF REQUESTS USING STABLE MATCHING IN CLOUD COMPUTING SYSTEMS

(71) Applicant: SAP SE, Walldorf (DE)

(72) Inventor: Hui Li, Shanghai (CN)

(21) Appl. No.: 18/945,646

(22) Filed: Nov. 13, 2024

(51) Int. Cl. G06F 9/50

(52) U.S. Cl. CPC G06F 9/5083

(57) ABSTRACT

Methods, systems, and computer-readable storage media for receiving requests for distribution to a group of N servers, each request being received from a tenant, determining characteristics of each of the N requests, determining, for each request, a set of request-to-server preference values using the characteristics, determining, for each server, a set of server-to-request preference values, determining a plurality of potential sets of distributions based on the set of request-to-server preference values and the set of server-to-request preference values, each distribution including a request and server pair, determining one set of distributions from the plurality of potential sets of distributions where're the one set of distributions is selected as the actual set of distributions, and distributing, by the gateway, at least a portion of the group of N requests to at least a portion of the group of N servers using the actual set of distributions.

### BACKGROUND

Cloud computing can be described as Internet-based computing that provides shared computer processing resources and data to computers and other devices on demand. Users can establish respective sessions, during which processing resources and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand.

Multiple instances of the enterprise application can be executed on respective application servers within the cloud computing environment. For example, multiple tenants can access an enterprise resource planning (ERP) system, wherein instances of the ERP system are executed on multiple application servers. That is, multiple application servers execute respective instances of the same application (e.g., ERP system). As such, clients (e.g., tenant-side computing devices) transmit requests to the cloud computing environment, which requests are routed to one of the application servers for processing. In traditional cloud computing environments, a load balancer (e.g., executing at a gateway of the cloud computing environment) dispatches requests to application servers using a dispatch policy.

### SUMMARY

Implementations of the present disclosure are directed to load balancing for distributing requests-to-servers in cloud computing systems. More particularly, implementations of the present disclosure are directed to a load balancer that uses stable matching to account for quality of service (QoS) of disparate tenants in distributing requests-to-servers in cloud computing systems. As described in further detail herein, the load balancer of the present disclosure improves resource utilization across servers that execute the requests and ensures QoS in request handling.

In some implementations, actions include receiving requests for distribution by a gateway to a group of N servers of a cloud computing environment, each request being received from a tenant of a set of tenants, determining characteristics of each of the N requests, determining, for each request in a group of N requests, a set of request-to-server preference values using the characteristics of each of the N requests, determining, for each server in the set of N servers, a set of server-to-request preference values, determining a plurality of potential sets of distributions based on the set of request-to-server preference values and the set of server-to-request preference values, each distribution including a request and server pair, determining one set of distributions from the plurality of potential sets of distributions where're the one set of distributions is selected as the actual set of distributions, and distributing, by the gateway, at least a portion of the group of N requests to at least a portion of the group of N servers using the actual set of distributions. Other implementations of this aspect include corresponding systems, apparatus, and computer programs, configured to perform the actions of the methods, encoded on computer storage devices.

These and other implementations can each optionally include one or more of the following features: actions further include retrieving a set of server metrics and a set of request costs, the set of request-to-server preference values being determined using the set of server metrics and the set of request costs; action further include retrieving a set of server metrics and a set of request costs, the set of server-to-request preference values being determined using the set of server metrics and the set of request costs; providing a set of distributions based on the set of request-to-server preference values and the set of server-to-request preference values, each distribution including a request and server pair includes determining, for each request, a request-to-server preference order based on the request-to-server preference values, determining, for each server, a server-to-request preference order based on the server-to-request preference values, and processing the request-to-server preference orders and the server-to-request preference orders using the Gale-Shapley algorithm to determine the actual set of distributions; actions further include adding a request to the group of N requests in response to determining that the request is included in a request list; actions further include determining that a time is equal to a threshold time, and in response, adding one or more mock requests to define the group of N requests; distributing, by the gateway, at least a portion of the group of N requests to at least a portion of the group of N servers using the set of distributions includes distributing only non-mock requests in the group of N requests; for each tenant, the set of request-to-server preference values is determined at least partially based on a time delay threshold and an error rate threshold that is defined for the tenant; and actions further include executing a request of the group of N requests, forwarding server execution data representative of execution of the request, and storing the server execution data to generate a request cost for the request.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example cloud computing system in accordance with implementations of the present disclosure.

FIGS. 3A-3C depict a plurality of request distributions in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to load balancing for distributing requests-to-servers in cloud computing systems. More particularly, implementations of the present disclosure are directed to a load balancer that uses stable matching to account for quality of service (QoS) of disparate tenants in distributing requests-to-servers in cloud computing systems. As described in further detail herein, the load balancer of the present disclosure improves resource utilization across servers that execute the requests and ensures QoS in request handling.

Implementations can include actions of receiving requests for distribution by a gateway to a group of N servers of a cloud computing environment, each request being received from a tenant of a set of tenants, determining characteristics of each of the N requests, determining, for each request in a group of N requests, a set of request-to-server preference values using the characteristics of each of the N requests, determining, for each server in the set of N servers, a set of server-to-request preference values, determining a plurality of potential sets of distributions based on the set of request-to-server preference values and the set of server-to-request preference values, each distribution including a request and server pair, determining one set of distributions from the plurality of potential sets of distributions where're the one set of distributions is selected as the actual set of distributions, and distributing, by the gateway, at least a portion of the group of N requests to at least a portion of the group of N servers using the actual set of distributions.

To provide further context for implementations of the present disclosure, and as introduced above, enterprises can use enterprise applications to support and execute operations. Enterprise applications can be deployed in cloud computing environments, which includes execution of the enterprise applications within a data center of a cloud-computing provider (e.g., as part of an infrastructure-as-a-service (IaaS) and/or a software-as-a-service (SaaS) offering). Cloud computing can be described as Internet-based computing that provides shared computer processing resources, and data to computers and other devices on demand.

Enterprise applications can be deployed for access by multiple tenants. In some examples, each tenant can include an enterprise that is able to access the enterprise application in the cloud computing environment. For example, clients of tenants can establish respective sessions, during which processing resources, and bandwidth are consumed. A client can include, for example and without limitation, a user (e.g., using a tenant-side computing device) of an application (e.g., executing on a tenant-side computing device). During a session, for example, a client is provided on-demand access to the enterprise application, which is executed using a shared pool of configurable computing resources (e.g., computer networks, servers, storage, applications, and services).

Multiple instances of the enterprise application can be executed on respective application servers within the cloud computing environment. For example, multiple tenants can access an enterprise resource planning (ERP) system, wherein instances of the ERP system are executed on multiple application servers. That is, multiple application servers execute respective instances of the same application (e.g., ERP system). As such, clients (e.g., tenant-side computing devices) transmit requests to the cloud computing environment, which requests are routed to one of the application servers for processing. In traditional cloud computing environments, a load balancer (e.g., executing at a gateway of the cloud computing environment) dispatches requests to application servers using a dispatch policy. Example dispatch policies include, without limitation, round-robin scheduling and modified round-robin scheduling. Such scheduling policies, however, are at the request level. Consequently, when a request hits the gateway of the cloud computing environment, the gateway will redirect the request to an application server based on the dispatch policy without regard to the particular tenant that the request originated from. In such scenarios, it is possible for all or a majority of the application servers to be receiving client requests from a single tenant where such a distribution outcome is not efficient for the cloud computing environment.

Moreover, different tenants have different grades of SLAs with providers of cloud computing environments. In general, a SLA guarantees a specified QoS for a respective tenant. In some examples, QoS can be defined in terms of rate of throughput (e.g., rate at which requests can be submitted), availability (e.g., of backend resources for handling requests), and latency (e.g., time required to handle requests and returns responses). Tenants having SLAs defining higher QoS should obtain better service than tenants having SLAs with lower QoS. For example, the cloud computing system should guarantee that requests from tenants having higher QoS should be performed before requests from tenants having lower QoS.

However, requests have different impacts on consumption of resources of severs handling the requests. For example, some requests consume more processing (CPU) resources, but few memory resources, while other requests consume more memory resources, but few processing resources. In traditional load balancing approaches (e.g., stochastic, polling, weighted polling, minimum number of connections), only one-sided server resource utilization or response time is considered, without considering the different demands of different tenants on QoS, or the balance of the combinations of processing resources and memory resources.

In view of the foregoing, implementations of the present disclosure provide load balancing that uses stable matching to account for QoS of disparate tenants in distributing requests-to-servers in cloud computing systems. As described in further detail herein, the load balancing of the present disclosure improves resource utilization across servers that execute the requests and ensures QoS in request handling.

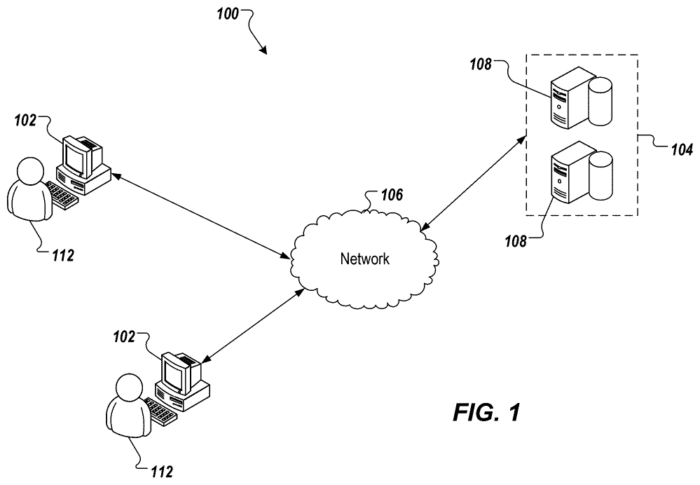

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In accordance with implementations of the present disclosure, the server system 104 can host servers that process requests and a gateway that distributes requests to the servers for processing. As described in further detail herein, the gateway implements load balancing using stable matching to account for QoS of disparate tenants in distributing requests-to-servers to improve resource utilization across servers that execute the requests and to ensure QoS in request handling.

Implementations of the present disclosure are described in further detail herein with reference to requests sent using the hypertext transfer protocol (HTTP). It is contemplated, however, that implementations of the present disclosure can be realized using any appropriate protocol.

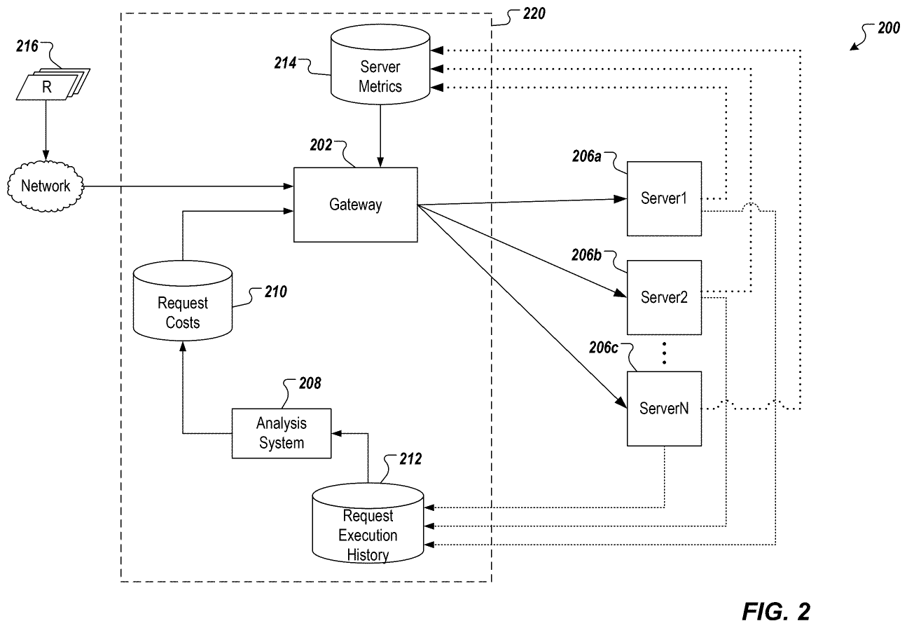

FIG. 2 depicts an example cloud computing system 200 in accordance with implementations of the present disclosure. In the depicted example, the cloud computing system 200 includes a gateway 202, servers 206a, 206b, 206c, an analysis system 208, a request costs datastore 210, a request execution history datastore 212, and a server metrics datastore 214. In some examples, components of the cloud computing system 200 can be included in a load balancing system 220 of the present disclosure. In the example of FIG. 2, the load balancing system 220 includes the gateway 202, the analysis system 208, the request costs datastore 210, the request execution history datastore 212, and the server metrics datastore 214.

In some examples, the gateway 202 receives requests 216 from multiple tenants of the cloud computing system 200. In some examples, each request 216 is associated with a HTTP method and a uniform resource indicator (URI). The servers 206a, 206b, 206c execute respective instances of at least a portion of an application and receive the requests 216 from the multiple tenants for processing. As described in further detail herein, the load balancing system 220 distributes the requests 216 to the servers 206a, 206b, 206c using stable matching to improve resource utilization across the servers 206a, 206b, 206c and ensure that the QoS of the respective tenants is met in request handling.

In accordance with implementations of the present disclosure, requests are continuously sent to the gateway 202, which handles every N requests as a group according to the chronological order of the requests as the requests are received. The requests in each group of N requests are distributed by the gateway 202 to servers in a group of N servers (e.g., including the servers 206a, 206b, 206c). After the group of N requests is distributed to servers in the group of N servers, a next group of N requests is distributed to servers in the group of N servers, and the process continues. In instances where there are less than N requests, mock requests are included to provide N requests, as described in further detail herein. It can be noted that each tenant can have multiple users issuing requests to the cloud computing system 200. As such, a group of N requests can include multiple requests issued by one tenant.

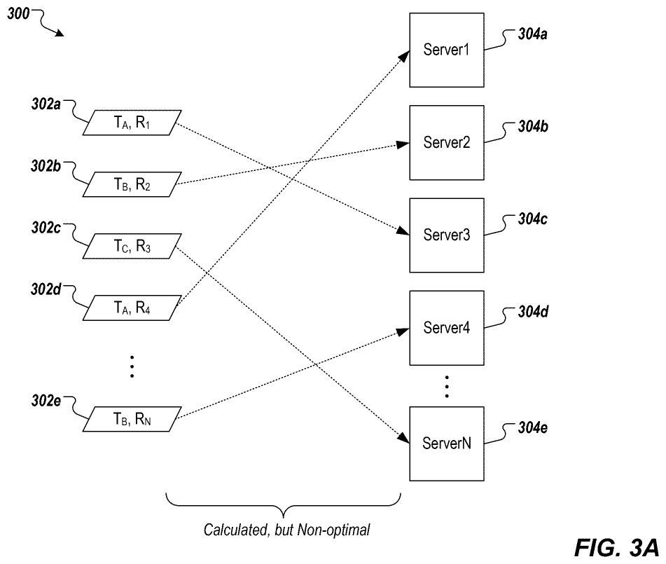

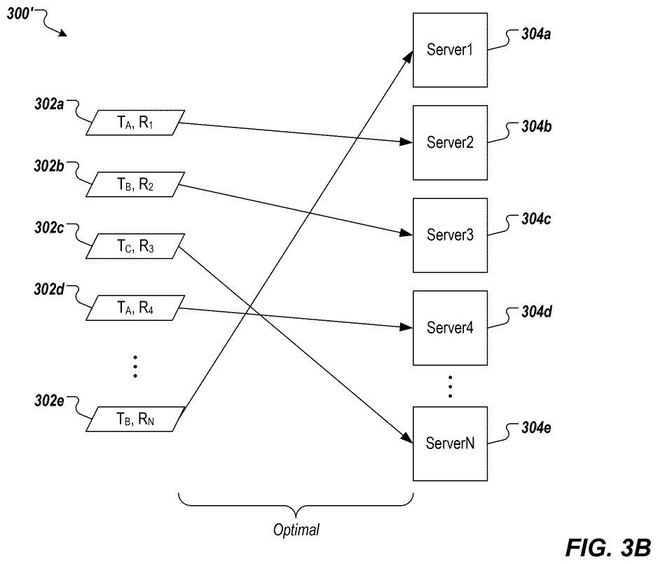

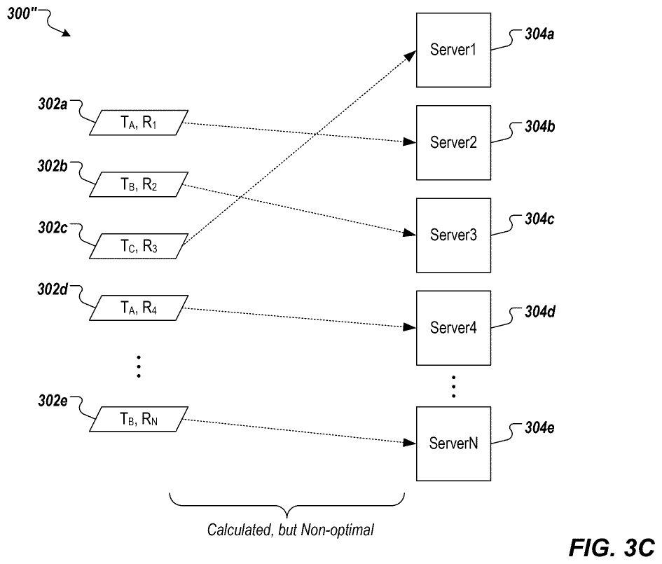

FIGS. 3A-3C depict example request distributions 300, 300′, 300″ in accordance with implementations of the present disclosure. In the depicted example, requests 302a, 302b, 302c, 302d, 302e are distributed to servers 304a, 304b, 304c, 304d, 304c, as described herein. FIGS. 3A and 3C represent potential sets of distributions 300, 300″ of requests-to-servers that are generated by gateway 202, but were not ultimately selected for an actual set of distributions of requests-to-servers. FIG. 3B was a potential set of distributions of requests-to-servers, but as the gateway 202 determined this potential set of distributions to be the most optimal from among the plurality of sets of distributions, it was selected as the actual set of distributions of requests-to-servers. As represented in FIGS. 3A-3C, the requests 302a, 302d are from the same tenant (TA) and the requests 302b, 302e are from the same tenant (TB).

Referring again to FIG. 2, for each group of N requests, the gateway 202 reads request costs for each request from the request cost datastore 210. In some examples, for each request, request costs are read from the request cost datastore 210 using the HTTP method and URI of the request as an index. Also, for each server in the group of N servers, the gateway 202 reads server metrics from the server metrics datastore 214. Each server 206a, 206b, 206c writes its server metrics to the server metrics datastore 214 at regular intervals. Example server metrics can include remaining CPU percentage, remaining memory percentage, current response time, current success rate, and the like. In some implementations, for each request, the gateway 202 calculates a set of preference values, each preference value corresponding to a respective request and server pair, as described in further detail herein.

As described in further detail herein, the gateway 202 distributes the N requests to the N servers based on the preference values using a stable matching algorithm. In general, stable matching can be described as finding stable matches between two equally sized sets of elements given an ordering of preferences for each element. In the context of the present disclosure, the equally sized sets of elements include the N requests and the N servers and preferences can be ordered using the preference values, as described herein. After executing a request, each server 206a, 206b, 206c writes an execution history of the request to the request execution history datastore 212. In some examples, the execution history of a request can include a time cost, a memory cost, and a CPU cost, which respectively indicate the time and resources consumed in executing the request. In some examples, the analysis system reads the execution history of the requests from the request execution history datastore 212 for a defined period and calculates request costs for the respective requests. Example request costs can include a CPU utilization and a memory utilization of and time to execute each request.

In further detail, the request execution history datastore 212 stores a table, REQUEST_EXEC_HISTORY, that records the execution histories of the requests. Table 1 provides an example of a REQUEST_EXEC_HISTORY table:

TABLE 1
Example Request Execution History Table

| Column | Type | Remark |
|---|---|---|
| HTTP_METHOD | String | HTTP method of the request (e.g., |
| | | GET, POST, PUT, DELETE, |
| | | PATCH, HEAD) |
| URI | String | relative URI of the request, excluding |
| | | certain parameters (e.g.,/rest/v1/User) |
| EXECUTION_TIME- | Time- | timestamp of when the request |
| STAMP | stamp | executed |
| COST_TIME | Long | time cost to execute the request |
| COST_CPU_TIME | Long | CPU cost to execute the request |
| COST_MEMORY | Long | memory cost to execute the request |

The request cost datastore 210 stores a table. REQUEST_COST, that records the request costs of the requests. Table 2 provides an example of a REQUEST_COST table:

TABLE 2
Example Request Costs Table

| Column | Type | Remark |
|---|---|---|
| HTTP_METHOD | String | HTTP method of the request |
| | | (e.g., GET, POST, PUT, |
| | | DELETE, PATCH, HEAD) |
| URI | String | relative URI of the request, |
| | | excluding certain parameters |
| | | (e.g.,/rest/v1/User) |
| MEAN_CPU_USAGE | Double | mean CPU usage of the request |
| | | (e.g., value is in range of |
| | | [0, 1]; if the request |
| | | has not been previously executed |
| | | (new request), use the mean |
| | | value of all other requests by |
| | | default) |
| MEAN_MEMORY_USAGE | Double | mean memory usage of the |
| | | request (e.g., value is in range |
| | | of [0, 1]; if the request |
| | | has not been previously executed |
| | | (new request), use the mean |
| | | value of all other requests |
| | | by default) |

In the example of Table 2, the request costs for each request includes mean CPU usage and mean memory usage.

In some implementations, and as noted above, the gateway has N requests to distribute to the N servers. The gateway has read the metrics of each server and the historical resource consumption data of each request pattern (a request pattern being the HTTP_METHOD and URI pair). In determining distribution of the requests, the following example variables can be considered:

TABLE 3
Example Variables for Request Distribution

| Variable | Remark |
|---|---|
| reqDelayᵢ | Response time delay threshold required by the tenant |
| | corresponding to requestᵢ. The unit is a millisecond. |
| reqErrorᵢ | Response error rate threshold required by the tenant |
| | corresponding to requestᵢ. The value is in scope [0, 1] |
| reqCPUᵢ | Historical average CPU utilization for request pattern of |
| | requestᵢ. It is the value of column MEAN_CPU_USAGE |
| | in table REQUEST_COST. The value is in scope [0, 1] |
| reqMemᵢ | Historical average memory utilization for request pattern of |
| | requestᵢ. It is the value of column |
| | MEAN_MEMORY_USAGE in table REQUEST_COST. |
| | The value is in scope [0, 1] |
| serverDelayᵢ | Response time delay of serverᵢ. The unit is a millisecond. |
| serverErrorᵢ | Response error rate of the serverᵢ. The value is in in scope |
| | [0, 1] |
| serverCPUᵢ | Remaining CPU percentage of serverᵢ. The value is in in |
| | scope [0, 1] |
| serverMemᵢ | Remaining memory percentage of serverᵢ. The value is in in |
| | scope [0, 1]. |

The gateway determines preference orders for requests-to-servers (r2s) based on each the tenant's respective QoS (e.g., some tenants prefer lower error rates with higher response times, while other tenants prefer lower response times delay with higher error rates).

In general, the more errors a server has, the more unhealthy the server is considered to be, and the more likely it is that subsequent requests will have errors. Example errors can include network timeout exceptions, disk IO errors, and CPU over-temperature errors. For example, a network timeout exception means that there is a problem with the server's network connection hardware or software, or some processes or threads on the server are consuming a lot of bandwidth, such that other processes or threads cannot use the network normally. A disk IO error means that there is a problem with the disk configuration of the server, or some process or thread on the server is reading or writing to a large number of disks and other processes or threads are not able to read or write to the disks properly. A CPU over-temperature error occurs when the temperature of a CPU exceeds a threshold temperature. For example, some servers have poor heat dissipation conditions, which results in the temperature of the CPU increasing.

In further detail, a degree of compatibility comp_{i,j} for request; to serverⱼ can be determined using the following example relationships:

$${delayDiff}_{i , j} = {reqDelay}_{i} - {serverDelay}_{j} \qquad ( 1 )$$

$${errorDiff}_{i , j} = {reqError}_{i} - {serverError}_{j} \qquad ( 2 )$$

$${z}_{i , j} = {w}_{1} \times {delayDiff}_{i , j} + {w}_{2} \times {errorDiff}_{i , j} \qquad ( 3 )$$

$${comp}_{i , j} = sigmoid ( {z}_{i , j} ) = \frac{1}{1 + {e}^{- {z}_{i , j}}} \qquad ( 4 )$$

Here, w₁ is a positive constant that represents a weight of the response time delay, w₂ is a positive constant that represents the weight of the response error rate, and a value scope of z_{i,j} is (−∞, +∞). Using the sigmoid function, the value scope of comp_{i,j} is scope (0, 1).

It can be seen that the degree of combability comp_{i,j} is a decreasing function of serverDelayⱼ and serverErrorⱼ, and an increasing function of reqDelayᵢ and reqErrorᵢ. As it is not desirable to distribute a request to a server with a higher response time delay and/or a higher error rate than a respective tenant requires (unless there is no other option), the preference score r2s_{i,j} for request; to server; can be provided by the following example relationship:

$$r 2 {s}_{i , j} = \{ \begin{matrix}{comp}_{i , j} - 1 , if {serverDelay}_{j} > {reqDelay}_{i} and {serverError}_{j} > reqError \\ {comp}_{i , j} - 0.5 , or if {serverDelay}_{j} > {reqDelay}_{i} or {serverError}_{j} > reqE \\ {comp}_{i , j} , if {serverDelay}_{j} \leq {reqDelay}_{i} and {serverError}_{j} \leq reqError\end{matrix} \qquad ( 5 )$$

Accordingly, r2s_{i,j} is a segmented function that is divided into multiple segments. In a first segment, if serverDelayⱼ is greater than reqDelayᵢ and serverErrorⱼ is greater than reqErrorᵢ, then comp_{i,j} is in scope (0,0.5) and r2s_{i,j} is in scope (−1,−0.5). In a second segment, if serverDelayⱼ is greater than reqDelayᵢ, or serverErrorⱼ is greater than reqErrorᵢ, then comp_{i,j} is in scope (0,1) and r2s_{i,j} is in scope (−0.5,0.5). In a third segment, if serverDelayⱼ is less than or equal to reqDelayᵢ and serverErrorⱼ is less than or equal to reqErrorᵢ, then comp_{i,j} is in scope (0.5, 1) and r2s_{i,j} is in scope (0.5, 1). In each segment, r2s_{i,j} is a decreasing function of serverDelayⱼ and serverErrorⱼ and is an increasing function of reqDelayᵢ and reqErrorᵢ.

The gateway can generate a preference score matrix between N requests and N servers. The preference score matrix can be provided as:

$$R 2 S = [ \begin{matrix}r 2 {s}_{1 , 1} & r 2 {s}_{1 , 2} & ⋯ & r 2 {s}_{1 , n} \\ r 2 {s}_{2 , 1} & r 2 {s}_{2 , 2} & ⋯ & r 2 {s}_{2 , n} \\ ⋯ & ⋯ & ⋯ & ⋯ \\ r 2 {s}_{n , 1} & r 2 {s}_{n , 2} & ⋯ & r 2 {s}_{n , n}\end{matrix} ]$$

where r2s_{i,j} can represent a degree to which request; prefers serverⱼ. For each requestᵢ, a preference order to servers is provided as the set of r2s_{i,1}, r2s_{i,2}, . . . , r2s_{i,n} in descending order. A non-limiting example can be considered, in which N is equal to 4 and the preference score matrix between N requests and N servers is provided as:

$$R 2 S = [ \begin{matrix}0.90 & 0.56 & 0.44 & 0.76 \\ 0.82 & 0.58 & 0.77 & 0.39 \\ 0.46 & 0.91 & 0.74 & 0.59 \\ 0.82 & 0.63 & 0.75 & 0.34\end{matrix} ]$$

In this example, the preference orders for requests-to-servers are provided in Table 4.

TABLE 4
Example Preference Orders

| Request | Preference order to Servers | Remark |
|---|---|---|
| request₁ | server₁, server₄, server₂, | r2s_{1, 1} = 0.90 > r2s_{1, 4} = 0.76 > |
| | server₃ | r2s_{1, 2} = 0.56 > r2s_{1, 3} = 0.44 |
| request₂ | server₁, server₃, server₂, | r2s_{2, 1} = 0.82 > r2s_{2, 3} = 0.77 > |
| | server₄ | r2s_{2, 2} = 0.58 > r2s_{2, 4} = 0.39 |
| request₃ | server₂, server₃, server₄, | r2s_{3, 2} = 0.91 > r2s_{3, 3} = 0.74 > |
| | server₁ | r2s_{3, 4} = 0.59 > r2s_{3, 1} = 0.46 |
| request₄ | server₁, server₃, server₂, | r2S_{4, 1} = 0.82 > r2_{4, 3} = 0.75 > |
| | server₄ | r2s_{4, 2} = 0.63 > r2s_{4, 4} = 0.34 |

In accordance with implementations of the present disclosure, preference orders for servers-to-requests (s2r_{i,j}) are determined using a balance of combinations of CPU and memory resources. For example, a server with remaining resource {CPU: 50%, memory: 45%} can be considered in view of two requests, request₁ that will consume {CPU: 5%, memory: 10%} and request₂ that will consume {CPU: 10%, memory: 5%} (determined from the request costs datastore). If the server processes request₁, its remaining resource becomes {CPU: 45%, memory: 35%}. If the server processes request₂, its remaining resource becomes {CPU: 40%, memory: 40%}. In this non-limiting example, the server will prefer request₂ to request₁, because the CPU and memory utilization are more balanced.

In further detail, a degree of balance balance_{i,j} for serverᵢ to requestⱼ can be determined by the following example relationships:

$${cpuRemaining}_{i , j} = {serverCPU}_{i} - {reqCPU}_{j} \qquad ( 6 )$$

$${memRemaining}_{i , j} = {serverMem}_{i} - {reqMem}_{j} \qquad ( 7 )$$

$${balance}_{i , j} = 1 - \vert {cpuRemaining}_{i , j} - {memRemaining}_{i , j} \vert \qquad ( 8 )$$

Here, |x| is the absolute value of x and the value scope of the degree of balance is [0, 1]. As it is not desirable to distribute a request to a server with a lower remaining CPU or lower remaining memory percentage than the request requires, the preference score s2r_{i,j} for serverᵢ to requestⱼ by the following example relationship:

$$s 2 {r}_{i , j} = \{ \begin{matrix}- 1 , & if {reqCPU}_{j} > {serverCPU}_{i} or {reqMem}_{j} > {serverMem}_{i} \\ {balance}_{i , j} , & if {reqCPU}_{j} \leq {serverCPU}_{i} and {reqMem}_{j} \leq {serverMem}_{i}\end{matrix} \qquad ( 9 )$$

The preference score matrix between N servers and N requests can be provided as:

$$S 2 R = [ \begin{matrix}s 2 {r}_{1 , 1} & s 2 {r}_{1 , 2} & ⋯ & s 2 {r}_{1 , n} \\ s 2 {r}_{2 , 1} & s 2 {r}_{2 , 2} & ⋯ & s 2 {r}_{2 , n} \\ ⋯ & ⋯ & ⋯ & ⋯ \\ s 2 {r}_{n , 1} & s 2 {r}_{n , 2} & ⋯ & s 2 {r}_{n , n}\end{matrix} ]$$

where s2r_{i,j} represents a degree to which serverᵢ prefers requestⱼ. For each serverᵢ, a preference order to requests is provided by the set of s2r_{i,1}, s2r_{i,2}, . . . , s2r_{i,n} in descending order. A non-limiting example can be considered, in which N is equal to 4 and the preference score matrix between N servers and N requests is provided as:

$$S 2 R = [ \begin{matrix}0.52 & 0.67 & 0.83 & 0.18 \\ 0.73 & 0.92 & - 1 & 0.56 \\ 0.68 & 0.33 & 0.76 & 0.53 \\ 0.64 & 0.48 & 0.53 & 0.79\end{matrix} ]$$

In this example, the preference orders for servers and requests are provided in Table 5.

TABLE 5
Example Preference Orders

| Server | Preference Order to Requests | Remark |
|---|---|---|
| server₁ | request₃, request₂, | s2r_{1, 3} = 0.83 > s2r_{1, 2} = 0.67 > |
| | request₁, request₄ | s2r_{1, 1} = 0.52 > s2r_{1, 4} = 0.18 |
| server₂ | request₂, request₁, | s2r_{2, 2} = 0.92 > s2r_{2, 1} = 0.73 > |
| | request₄, request₃ | s2r_{2, 4} = 0.56 > s2r_{2, 3} = −1 |
| server₃ | request₃, request₁, | s2r_{3, 3} = 0.76 > s2r_{3, 1} = 0.68 > |
| | request₄, request₂ | s2r_{3, 4} = 0.53 > s2r_{3, 2} = 0.33 |
| server₄ | request₄, request₁, | s2r_{4, 4} = 0.79 > s2r_{4, 1} = 0.64 > |
| | request₃, request₂ | s2r_{4, 3} = 0.53 > s2r_{4, 2} = 0.48 |

In some implementations, stable matching for the requests and servers is performed using the Gale-Shapley algorithm according to the preference orders for requests-to-servers (r2s) and the preference orders for servers-to-requests (s2r). In general, the Gale-Shapley algorithm involves several iterations where, and in the context of the present disclosure, in each iteration, any subset of the requests that are unmatched to servers makes a matching request to the server that has the highest degree of preference among the servers not yet already matched. Each server that has received a matching request evaluates it against its current matching request (if it has one). If the server is not yet matched, or if the server receives a matching request from a request that has a higher degree of preference than the current matching request, the server accepts the matching request, becomes matched to the new request, and removes the matching to the previous matching request. The previous matching request becomes unmatched again. Otherwise, the server rejects the new matching request. This is repeated until every request is matched to some server.

Continuing with the examples of Tables 4 and 5, above, the following stable matches can be provided:

TABLE 6
Example Stable Matches

| # | Request | Servers |
|---|---|---|
| 1 | request₁ | server₄ |
| 2 | request₂ | server₁ |
| 3 | request₃ | server₂ |
| 4 | request₄ | server₃ |

The runtime complexity of this is O(N²), guarantees that every request is matched to one server, and all the matches are stable. The different preferences between requests and servers are satisfied maximumly at a global level, and the QoS of the requests and utilization of the balanced use of CPU and memory resources are satisfied at a global level.

As discussed above, after a server completes execution of a request, the server determines the time cost (time taken to execute the request), processing cost (CPU cycles consumed to execute the request), and memory cost (memory consumed to execute the request), which are written the request execution history datastore (e.g., in the REQUEST_EXEC_HISTORY table). The analysis system periodically reads the latest request execution history records from the REQUEST_EXEC_HISTORY table to determine (or update) the mean CPU utilization and the mean memory utilization of each request pattern (e.g., indexed by HTTP method and URI). The following example relationships can be used:

$$MEAN\_CPU \_USAGE = \frac{{\sum }_{k = 1}^{T} COST\_CPU {\_TIME}_{k}}{{\sum }_{k = 1}^{T} {COST\_TIME}_{k}} \qquad ( 10 )$$

$$MEAN\_MEMORY \_USAGE = \frac{{\sum }_{k = 1}^{T} {COST\_MEMORY}_{k}}{T \times SERVER\_MEMORY} \qquad ( 11 )$$

The variables for Equations 10 and 11 are defined in Table 7.

TABLE 7
Variable Definitions

| Variable | Definition |
|---|---|
| T | The count of execution history records of |
| | request pattern (with the same HTTP |
| | method and URI) in a time window. |
| COST_CPU_TIMEₖ | The CPU time cost of the k^{th} |
| | execution history record of the request |
| | pattern (with the same HTTP method |
| | and URI). |
| COST_TIMEₖ | The time cost of the k^{th} |
| | execution history record of the request |
| | pattern (with the same HTTP method |
| | and URI). |
| MEAN_CPU_USAGE | The mean CPU utilization of the request |
| | pattern (with the same HTTP method |
| | and URI). |
| COST_MEMORYₖ | The memory cost of the k^{th} |
| | execution history record of the request |
| | pattern (with the same HTTP method |
| | and URI) |
| SERVER_MEMORY | The total memory size of one server. |
| MEAN_MEMORY_USAGE | The mean memory utilization of the |
| | request. |

In some implementations, the analysis system will update the mean CPU utilization and the mean memory utilization of each request to the REQUEST_COST table to be made available for the gateway in distributing subsequent requests.

In some implementations, enhancements can be provided to minimize any latency that can arise in distributing requests, as described herein. An example enhancement can include providing a request list that identifies relatively complex requests (e.g., requests having relatively long latency, error-prone, consume significant CPU cycles, consume significant memory), for which distribution based on preferences is to be performed, as described herein. For example, the gateway can store a request list and compare incoming requests to the request list (e.g., based on HTTP method and URI). If a request is on the request list, the request is added to a group of requests and the group of requests are distributed as described herein (after the group includes N requests). If a request is not included in the request list, the request is distributed to a server using a traditional load balancing approach. Another example enhancement can include setting a time window threshold, such that, if the gateway receives N requests included in the request list when the time window is less than or equal to a threshold time, N requests are distributed to the N servers based on order preferences, as described herein. If the time window has reached the threshold time and the gateway receives less than N requests included in the request list, mock requests are used fill the queue to N. In some examples, each mock request is assigned the lowest preference scores. Distributions are determined for the N requests (e.g., including M mock requests) and only the non-mock requests (e.g., N-M) are forwarded to their respective servers.

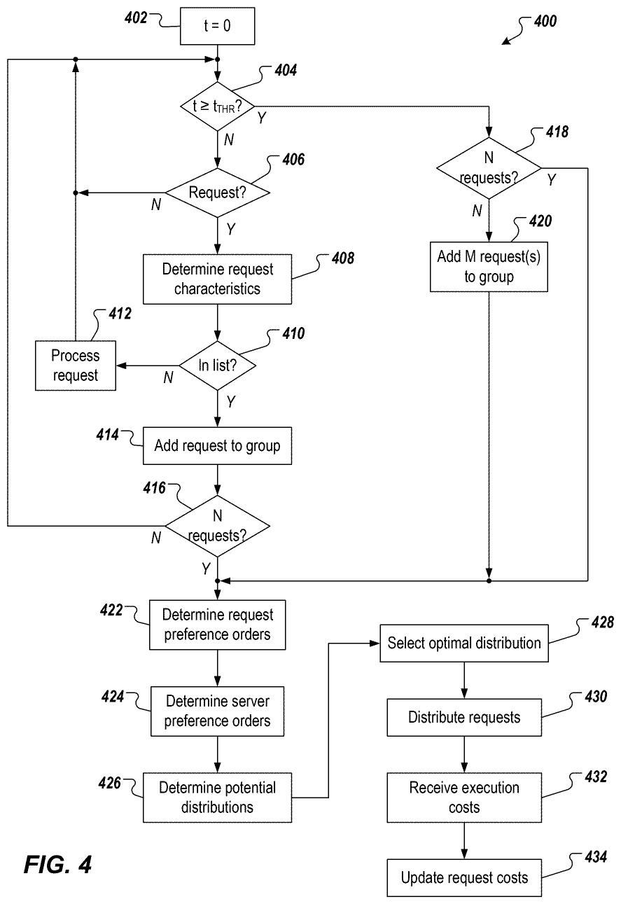

FIG. 4 depicts an example process 400 that can be executed in accordance with implementations of the present disclosure. In some examples, the example process 400 is provided using one or more computer-executable programs executed by one or more computing devices.

A timer (t) is set (reset) equal to zero (402). The timer t will automatically time itself at regular time intervals (e.g., small time windows), independently of the system. The system monitors the timer t and it is determined whether the timer t meets or exceeds a time threshold (t_{THR}). If the timer t does not meet or exceed the time threshold, it is determined whether a request has been received (406). If no request is received since the time t was last incremented, the example process 400 loops back. If a request is received, characteristics of the request are determined (408). For example, and as described herein with reference to FIG. 2, the gateway 202 receives a request 216 from a tenant. In some examples, some of the characteristics of the request are associated with a HTTP method and a URI. It is determined whether the request is in a request list (410). For example, and as described herein, the gateway 202 can reference a request list that indexes requests based on HTTP method and URI. The gateway can reference the request against the request list, using the HTTP method and URI of the request, to determine whether the request is in the request list. If the request is not in the request list, the request is processed (412) and the example process 400 loops back. For example, and as described herein, the request 216 can be dispatched to one of the servers 206a, 206b, 206c using a dispatch policy (e.g., round-robin).

If, however, the request is in the request list, the request is added into a group (414). It is determined whether the group of requests includes N requests (416). If the group of requests does not include N requests, the example process 400 loops back. If the timer t meets or exceeds the time threshold, it is determined whether a request count is less than N. If the request count is less than N, one or more mock requests are added to the group (420). For example, and as described herein, there are P requests in the group of requests, where P is less than N. In this case, M mock requests are added to define a group of N requests, where N=P+M. As described herein, each mock request is assigned the lowest preference score (−1).

When the group of requests includes N requests, request preference orders are determined (422). For example, and as described herein, for each request and server pair a r2s is determined (see, e.g., Table 4 and respective discussion). Server preference orders are determined (424). For example, and as described herein, for each server and request pair a s2r is determined (see, e.g., Table 5 and respective discussion).

Potential distributions of requests are determined (426) and an optimal distribution is selected (428). For example, and as described herein, the request preference orders and the server preference orders are processed using the Gale-Shapley algorithm to determine distributions as server and request pairs, each indicating a server that a request is to be distributed to (see, e.g., Table 6 and respective discussion). Each server and request pair being determined to be a stable match. Requests are distributed (430). For example, and as described herein, the gateway distributes the requests to the servers using the distributions. If any mock requests had been included in the group of N requests, only the non-mock requests are distributed.

Request execution costs are received (432). For example, and as described herein, after executing a request, each server records request metrics to the request execution history datastore. Request costs are updated (434). For example, and as described herein, the analysis system receives request execution costs and updates the request costs, as described herein, and stores the (updated) request costs in the request cost datastore.

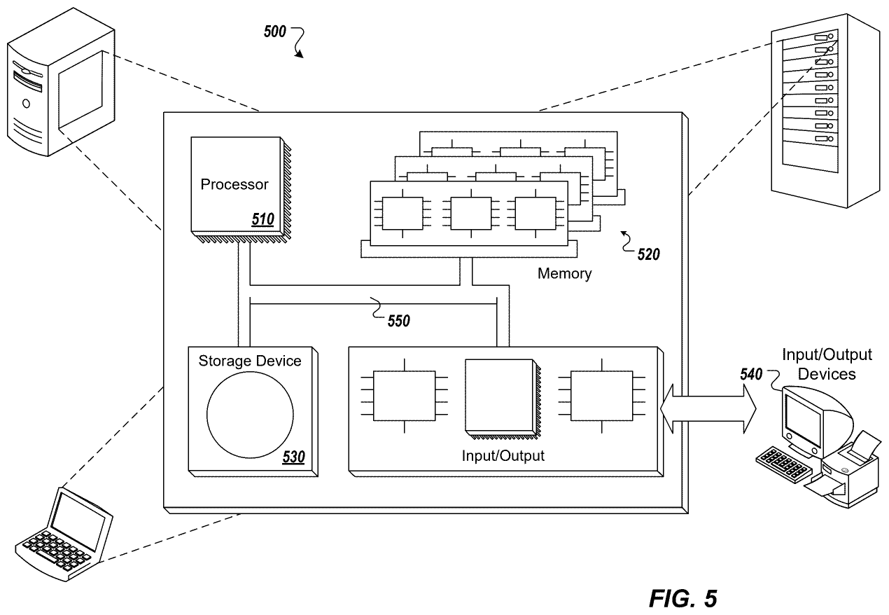

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for distributing requests-to-servers for execution in cloud computing environments, the method being executed by one or more processors and comprising:
receiving requests for distribution by a gateway to a group of N servers of a cloud computing environment, each request being received from a tenant of a set of tenants;
determining characteristics of each of the N requests;
determining, for each request in a group of N requests, a set of request-to-server preference values using the characteristics of each of the N requests;
determining, for each server in the set of N servers, a set of server-to-request preference values;
determining a plurality of potential sets of distributions based on the set of request-to-server preference values and the set of server-to-request preference values, each distribution comprising a request and server pair;
determining one set of distributions from the plurality of potential sets of distributions where're the one set of distributions is selected as the actual set of distributions; and
distributing, by the gateway, at least a portion of the group of N requests to at least a portion of the group of N servers using the actual set of distributions.

2. The method of claim 1, further comprising retrieving a set of server metrics and a set of request costs, the set of request-to-server preference values being determined using the set of server metrics and the set of request costs.

3. The method of claim 1, further comprising retrieving a set of server metrics and a set of request costs, the set of server-to-request preference values being determined using the set of server metrics and the set of request costs.

4. The method of claim 1, wherein providing a set of distributions based on the set of request-to-server preference values and the set of server-to-request preference values, each distribution comprising a request and server pair comprises:
determining, for each request, a request-to-server preference order based on the request-to-server preference values;
determining, for each server, a server-to-request preference order based on the server-to-request preference values; and
processing the request-to-server preference orders and the server-to-request preference orders using the Gale-Shapley algorithm to determine the actual set of distributions.

5. The method of claim 1, further comprising adding a request to the group of N requests in response to determining that the request is included in a request list.

6. The method of claim 1, further comprising determining that a time is equal to a threshold time, and in response, adding one or more mock requests to define the group of N requests.

7. The method of claim 5, wherein distributing, by the gateway, at least a portion of the group of N requests to at least a portion of the group of N servers using the set of distributions comprises distributing only non-mock requests in the group of N requests.

8. The method of claim 1, wherein, for each tenant, the set of request-to-server preference values is determined at least partially based on a time delay threshold and an error rate threshold that is defined for the tenant.

9. The method of claim 1, further comprising:
executing a request of the group of N requests;
forwarding server execution data representative of execution of the request; and
storing the server execution data to generate a request cost for the request.

10. A non-transitory computer-readable storage medium coupled to one or more processors and having instructions stored thereon which, when executed by the one or more processors, cause the one or more processors to perform operations for distributing requests-to-servers for execution in cloud computing environments, the operations comprising:
receiving requests for distribution by a gateway to a group of N servers of a cloud computing environment, each request being received from a tenant of a set of tenants;
determining characteristics of each of the N requests;
determining, for each request in a group of N requests, a set of request-to-server preference values using the characteristics of each of the N requests;
determining, for each server in the set of N servers, a set of server-to-request preference values;
determining a plurality of potential sets of distributions based on the set of request-to-server preference values and the set of server-to-request preference values, each distribution comprising a request and server pair;
determining one set of distributions from the plurality of potential sets of distributions where're the one set of distributions is selected as the actual set of distributions; and
distributing, by the gateway, at least a portion of the group of N requests to at least a portion of the group of N servers using the actual set of distributions.

11. The non-transitory computer-readable storage medium of claim 10, wherein operations further comprise retrieving a set of server metrics and a set of request costs, the set of request-to-server preference values being determined using the set of server metrics and the set of request costs.

12. The non-transitory computer-readable storage medium of claim 10, wherein further comprise retrieving a set of server metrics and a set of request costs, the set of server-to-request preference values being determined using the set of server metrics and the set of request costs.

13. The non-transitory computer-readable storage medium of claim 10, wherein providing a set of distributions based on the set of request-to-server preference values and the set of server-to-request preference values, each distribution comprising a request and server pair comprises:
determining, for each request, a request-to-server preference order based on the request-to-server preference values;
determining, for each server, a server-to-request preference order based on the server-to-request preference values; and
processing the request-to-server preference orders and the server-to-request preference orders using the Gale-Shapley algorithm to determine the actual set of distributions.

14. The non-transitory computer-readable storage medium of claim 10, wherein operations further comprise adding a request to the group of N requests in response to determining that the request is included in a request list.

15. The non-transitory computer-readable storage medium of claim 10, wherein operations further comprise determining that a time is equal to a threshold time, and in response, adding one or more mock requests to define the group of N requests.

16. A system, comprising:
a computing device; and
a computer-readable storage device coupled to the computing device and having instructions stored thereon which, when executed by the computing device, cause the computing device to perform operations for distributing jobs for distributing requests-to-servers for execution in cloud computing environments, the operations comprising:
receiving requests for distribution by a gateway to a group of N servers of a cloud computing environment, each request being received from a tenant of a set of tenants;
determining characteristics of each of the N requests;
determining, for each request in a group of N requests, a set of request-to-server preference values using the characteristics of each of the N requests;
determining, for each server in the set of N servers, a set of server-to-request preference values;
determining a plurality of potential sets of distributions based on the set of request-to-server preference values and the set of server-to-request preference values, each distribution comprising a request and server pair;
determining one set of distributions from the plurality of potential sets of distributions where're the one set of distributions is selected as the actual set of distributions; and
distributing, by the gateway, at least a portion of the group of N requests to at least a portion of the group of N servers using the actual set of distributions.

17. The system of claim 16, wherein operations further comprise retrieving a set of server metrics and a set of request costs, the set of request-to-server preference values being determined using the set of server metrics and the set of request costs.

18. The system of claim 16, wherein further comprise retrieving a set of server metrics and a set of request costs, the set of server-to-request preference values being determined using the set of server metrics and the set of request costs.

19. The system of claim 16, wherein providing a set of distributions based on the set of request-to-server preference values and the set of server-to-request preference values, each distribution comprising a request and server pair comprises:
determining, for each request, a request-to-server preference order based on the request-to-server preference values;
determining, for each server, a server-to-request preference order based on the server-to-request preference values; and
processing the request-to-server preference orders and the server-to-request preference orders using the Gale-Shapley algorithm to determine the actual set of distributions.

20. The system of claim 16, wherein operations further comprise adding a request to the group of N requests in response to determining that the request is included in a request list.
